(19) United States
(12) Patent Application Publication
(10) Pub. No.: US 2013/0200975 A1
(43) Pub. Date: Aug. 8, 2013

(54) INTEGRATED COMMON MODE, DIFFERENTIAL MODE AUDIO FILTER INDUCTOR

(71) Applicants: Todd Alexander Shudarek, West Bend, WI (US); Jeffrey David Brown, Port Washington, WI (US)

(72) Inventors: Todd Alexander Shudarek, West Bend, WI (US); Jeffrey David Brown, Port Washington, WI (US)

(73) Assignee: CRAMER COIL & TRANSFORMER CO., Saukville, WI (US)

(21) Appl. No.: 13/578,330

(22) PCT Filed: Feb. 12, 2010
(86) PCT No.: PCT/US10/23986

§ 371 Date: Oct. 2, 2012

(51) Int. Cl. H01F 27/28

(52) U.S. Cl. CPC H01F 27/28
USPC 336/170; 336/220

(57) ABSTRACT

An inductor including common mode and differential mode flux paths. The inductor comprises a first core having a first connecting portion. A first segment extends from a first end of the connecting portion. A second segment extends from a second end of the connecting portion and first bridge segment extends from a middle of the connecting portion. A first wiring arrangement is at least partially disposed around the first segment. A second core has a second connecting portion. A third segment extends from a first end of the connecting portion. A fourth segment extends from a second end of the connecting portion and a second bridge segment extends from a middle of the connecting portion. A second wiring arrangement is at least partially disposed around the third segment. A first suspension connects the first segment to the fourth segment. A second suspension connects the second segment to the third segment.

### BACKGROUND

The present invention relates to digital audio filter circuits.

The output of a Class D amplifier may be filtered to reduce EMI and improve system efficiency. These filters contain both common mode and differential mode filtering characteristics, which are typically provided by separate inductors. The inductors also need to be of small, low cost, and durable construction.

### SUMMARY

In one embodiment, the invention provides an inductor including common mode and differential mode flux paths. The inductor comprises a first core having a first connecting portion. A first segment extends from a first end of the connecting portion. A second segment extends from a second end of the connecting portion and first bridge segment extends from a middle of the connecting portion. A first wiring arrangement is at least partially disposed around the first segment. A second core has a second connecting portion. A third segment extends from a first end of the connecting portion. A fourth segment extends from a second end of the connecting portion and a second bridge segment extends from a middle of the connecting portion. A second wiring arrangement is at least partially disposed around the third segment. A first suspension connects the first segment to the fourth segment. A second suspension connects the second segment to the third segment. The first segment, second segment, third segment, and fourth segment cooperate to promote the common mode flux path. The first bridge segment and the second bridge segment cooperate to promote the differential mode flux path. The pluralities of spheres affect the reluctance of the common mode inductance path.

In another embodiment, the invention provides an inductor including common mode and differential mode flux paths. The inductor comprises a first core having a connecting portion. A first segment extends from a first end of the connecting portion. A second segment extends from a second end of the connecting portion and a bridge segment extends from a middle of the connecting portion. A first wiring arrangement is at least partially disposed around the first segment and a second wiring arrangement is at least partially disposed around the second segment. A second core has a first end, a second end and a middle portion between the first end and the second end. A first plurality of solid spheres and an adhesive connect the first segment to the first end. A second plurality of solid spheres and an adhesive connect the second segment to the second end. The first segment, second segment, first end, and second end cooperate to promote the common mode flux path, and the bridge segment and the intermediate portion cooperate to promote the differential mode flux path. The spheres affect the reluctance of the common mode inductance path.

In yet another embodiment, the invention provides an integrated common mode and differential mode inductor. The inductor comprises a first core and a second core. Each core has a first segment, a second segment, and a bridge between the first and second segments. A first gap is defined between the first segment of the first core and the second segment of the second core. The first gap includes a plurality of solid spheres. A second gap is defined between the second segment of the first core and the first segment of the second core. The second gap including a plurality of solid spheres. A third gap is defined between the bridge of the first core and the bridge of the second core. A first bobbin is disposed around the first segment of the first core and the second segment of the second core. A second bobbin is disposed around the second segment of the first core and the first segment of the first core. A first wiring arrangement and a second wiring arrangement are disposed around the first bobbin. A third wiring arrangement and a fourth wiring arrangement are disposed around the second bobbin. A magnetic shield is disposed between the first and second bobbin.

Other aspects of the invention will become apparent by consideration of the detailed description and accompanying drawings.

### BRIEF DESCRIPTION OF THE DRAWINGS

FIG. 1a is a schematic of a first wiring arrangement of an inductor according to the invention.

FIG. 1b is a schematic of a second wiring arrangement of an inductor according to the invention.

FIG. 2 is a top view of an inductor according to one construction of the invention.

FIG. 3 is a top view of a single core element of the inductor of FIG. 2.

FIG. 4 is a top view of an inductor according to an alternative construction of the invention.

FIG. 5 is top view of an inductor according to another alternative construction of the invention.

FIG. 6 is a perspective view of an exemplary construction of the inductor in FIG. 2.

FIG. 7 is a side view of an exemplary construction of the inductor show in FIG. 2 with a cross-sectional view.

FIG. 8 is a perspective view of an exemplary construction detail of the bobbin of the inductor shown in FIG. 6 and FIG. 7.

FIG. 9 is a representative diagram of a low pass filter for use with an amplifier.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

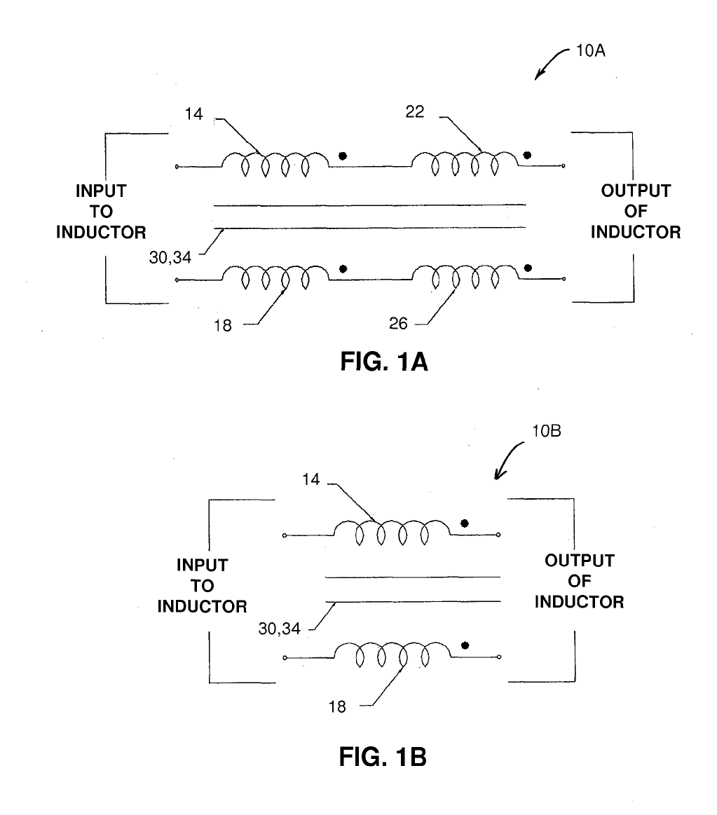

Figs. la and lb show schematic diagrams of two winding configurations of an inductor. Fig. la illustrates an inductor 10a with a first pair of windings 14 and 18 and a second pair of windings 22 and 26. One winding of each pair is disposed around a core 30, 34. FIG. 1b illustrates an inductor with first pair of winding 14 and 18 only. With the wiring arrangements arranged around the cores 30 and 34 with the polarities as shown in FIG. 1a, the common mode inductance is increased over the arrangement illustrated in FIG. 1b.

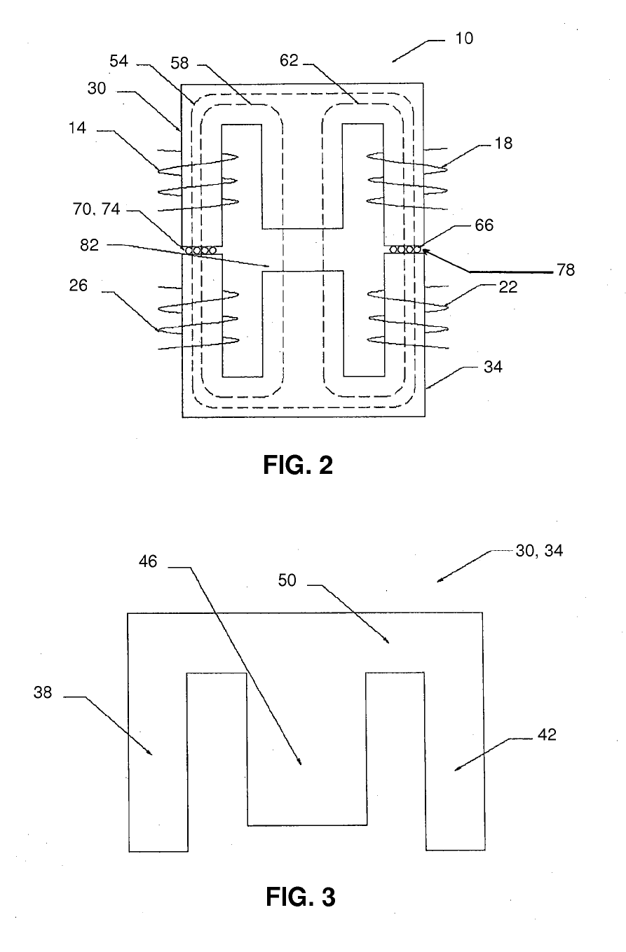

FIG. 2 illustrates an inductor 10 according to a first embodiment of the invention. The inductor 10 includes two cores 30 and 34. The cores 30 and 34 may also be referred to as core elements or core structures. Each of the cores 30 and 34 is a unitary piece and is manufactured from a magnetic material such as powdered iron, molypermalloy, ferrite or sendust. FIG. 3 illustrates the profile of a single core 30 or 34 of FIG. 2.

In the illustrated construction of FIG. 2, and in the corresponding view of an individual core shown in FIG. 3, each core 30 and 34 includes a first core segment 38, a second core segment 42, and a bridge 46. The term “core segment” may also be used interchangeably with “leg” or “core leg.” A connecting portion 50 connects the first core segment 38, second core segment 42 and the bridge 46. The term “connecting portion” may also be used interchangeably with “body,” “body portion,” “main body portion” or other terms to convey a similar meaning

As illustrated in FIG. 2, the first core segment 38 and second core segment 42 of the core 30 are utilized to support the windings 14 and 18 respectively. The corresponding segments 38 and 42 of the opposing core 34 support a second set of windings 22 and 26, respectively. This arrangement is also illustrated schematically in FIG. 1a. The core segments 38 and 42 can have a rectangular shape cross section, which allows coils (e.g., the wiring arrangement illustrated in FIG. 8) to be wound on similar cross-section shaped bobbins to slide onto core segments 38 and 42 of the corresponding cores 30 and 34. FIG. 2 shows the primary common mode magnetic flux path 54 and the primary differential mode magnetic flux paths 58 and 62.

In the construction illustrated in FIG. 2, the cores 30 and 34 are electro-magnetically and mechanically coupled to each other via the first and second core segments 38 and 42. In the illustrated embodiment, a plurality of spheres 66 held in an adhesive 70 forms a suspension 74 that fills the gaps 78 between the cores 30 and 34. The spheres 66 may be made from metals, glass, or polymers. The adhesive 70 may be an epoxy resin such as a potting compound. The invention is not limited to such a construction. A suspension is a solid dispersed in solid, liquid or gas. In other embodiments, a plurality of solid objects of any configuration may be suspended or bonded between the first and second core segments 38 and 42. Other configurations include cubes, diamonds, cylinders, pyramids, or other geometric patterns. In still other constructions, the spheres 66, or other solid objects, may be held within the gaps 78 without an adhesive 70. The bridges 46 of each of the cores 30 and 34 have an air space (i.e., air gap) 82 between them.

As will be recognized by those of skill in the art, the damping factor for a filter circuit is defined by the ratio of attenuation factor to the resonance frequency. The damping factor, at a given frequency, is controlled by the diameter, material, and amount of spheres 66 mixed with the adhesive 70. The greater the diameter, the higher the electrical conductivity of the spheres, and the greater the number of spheres 66 mixed with the adhesive 70, the greater the increase in damping factor the spheres 66 will provide.

An increase of the damping factor can be provided by the use of electrically conductive spheres 66. Since the spheres 66 are within the common mode flux path, 54, shown in FIGS. 2, 4, and 5, eddy currents can be created within the spheres 66 to increase losses, thereby increasing the damping factor of the common mode current. Use of electrically conductive spheres has the desirable characteristic of providing more damping at higher frequencies than lower frequencies. The eddy currents circulate with the spheres 66 at a rate proportional to the frequency of the magnetic flux that is passing through them. The use of conductive spheres in this manor in a Class D audio amplifier output filter circuit would have the desirable effect of negligibly increasing the losses at the audio frequencies that are under 20 kHz while still providing the required damping of modulation frequencies that are typically 200 kHz or greater.

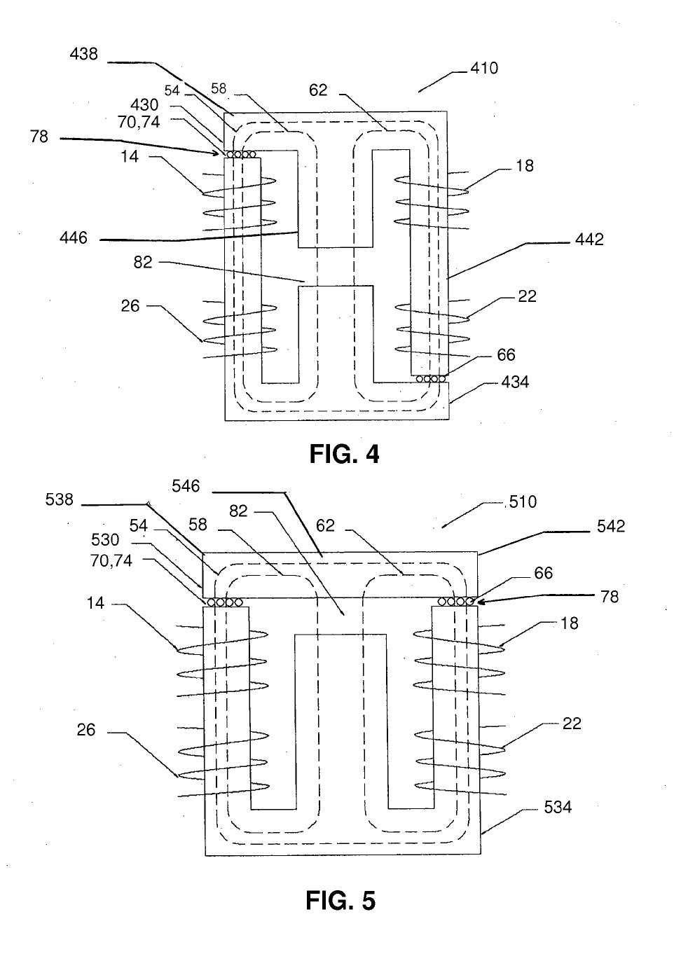

FIGS. 4 and 5 illustrate, respectively, alternative inductor constructions 410 and 510 to the inductor 10 illustrated in FIG. 2. Similar components to those illustrated in FIG. 2 are identified by the same reference numerals.

In the construction of FIG. 4, cores 430 and 434 are variations of the cores 30 and 34 of FIG. 2. The cores 430 and 434 are provided with windings 14, 18, 22 and 26 illustrated in alternative positions relative to the core segments (i.e., legs) 438 and 442. These constructions show other locations for the spheres 66. In particular, by varying the lengths of the core segments 438 and 442 and core bridge 446, the positions of the windings 14, 18, 22, and 26 with respect to the spheres 66 may be varied.

In the construction of FIG. 5, a first core 534 is a linear member having a first end 538, a second end 542, and a middle portion 546. The first end 538 corresponds in function to the first core segment 38 of core 30 in FIGS. 2 and 3. Similarly, the second end 542 corresponds to the second core segment 42 and the middle portion 546 corresponds to the bridge segment 46 and connecting portion 50.

It is beneficial that the inductors have precisely controlled differential and common mode inductance to control the filter tuning.

With reference to FIGS. 2, 4, and 5, the inductor includes two locations (i.e., the gaps 78) for spheres 66. The reluctance of the common mode flux path 54 for a given core shape is controlled by the permeability of the core material and the diameter of the spheres 66. Since there is, typically, a limited number of standard material permeabilities used to design the core structure, the resulting size may not be optimal. The spheres 66 of the illustrated constructions allow for the control of the reluctance of the common mode flux path 55. Particularly, adjusting a diameter of the spheres 66 and selecting the material of the cores allow adjusting the core permeability. For example, the larger the diameter of the spheres 66, the further the cores are spaced apart due to the diameter of the spheres, and the lower the common mode inductance is. Spheres 66 of precise diameter tolerance are available allowing for precision control of the common mode inductance. The shape of the spheres 66 allows for the adhesive 70 to flow between the spheres 66 and not vary the reluctance in the magnetic paths created by the diameter of the spheres 66.

Another method for adjusting common mode inductance is to vary the wiring arrangement. For example, the inductors illustrated in FIGS. 2, 4, and 5, includes two coils (e.g., coils 14, 26 and 18, 22) mounted on each half of the inductor 10, 410 or 510. To increase common mode inductance, the wiring arrangements on each of the outer core segments are arranged with the polarities as shown in FIG. 1a. Further, a greater number of turns in coils 14 and 18, as compared to coils 22 and 26, increases the common mode inductance. Although the constructions illustrated in FIGS. 2, 4 and 5 have structural differences, including the positions of the gaps 78 relative to the coils, they function similarly. In other embodiments, the sets of coils on each of the sets of core segments can be located anywhere along the core segments so long as the relative positions of the coils is controlled and repeatable in manufacturing.

The amount of differential mode inductance (illustrated in FIGS. 2, 4, and 5 by the differential mode flux paths 58 and 62), as compared to the common mode inductance, can be adjusted during the design phase of the inductor by adjusting and selectively changing the size of the air space 82 in the center of the inductor between the core bridges and/or by changing the width of the core bridges. For example, cores that define smaller air spaces 82 generally have proportionately more differential mode inductance.

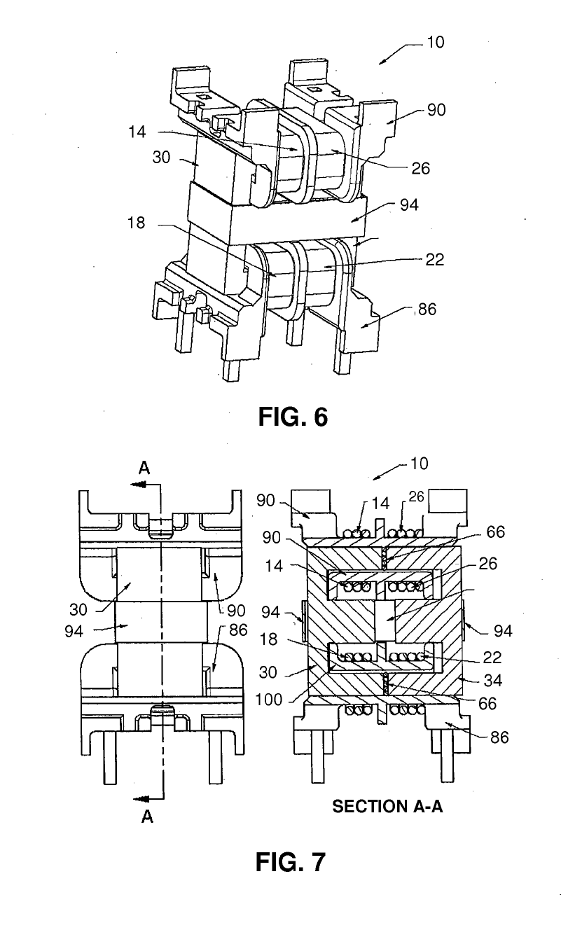

FIGS. 6 and 7 illustrate the inductor 10 of FIG. 2 as a complete assembly. FIG. 6 shows a perspective view of one construction. FIG. 7 shows the side view with a cross sectional view of the construction of FIG. 6. In the illustrated constructions of the cores 30 and 34, bobbins 86 and 90 are utilized to support windings 14, 18, 22, and 26. Further, in the construction illustrated in FIGS. 6 and 7, there can be a magnetic shield 94. This magnetic shield 94 is wrapped around the outside of the center bridges 46 and connecting portion 50 of the cores 30 and 34. The spheres 66 and adhesive 70 are also illustrated.

FIG. 8 shows a more detailed view of the bobbin 86. Stand-offs 98, 104, and 108 are provided to space the component away from a printed circuit board to prevent damage while soldering. Four terminals 112, 116, 120 and 124 are provided to electrically solder the component to the printed circuit board. In other constructions, there may be more than four terminals. The terminals 112, 116, 120, 124 are typically oriented downward on the component to minimize the amount of space the component requires on a printed circuit board. For example, see FIG. 6. Slots 128 in the bobbin 86 are provided for routing of the wires. The illustrated bobbin 86 has a flange 132 to separate the windings when the inductor has four coils. In a complete inductor assembly 10 (or in the alternative constructions 410 and 510), the flange 132 controls the positions of the coils 14 and 22 or 18 and 26 relative to each other. The flanges thereby affect the magnetic interaction between the coils, allowing for precise control of inductances.

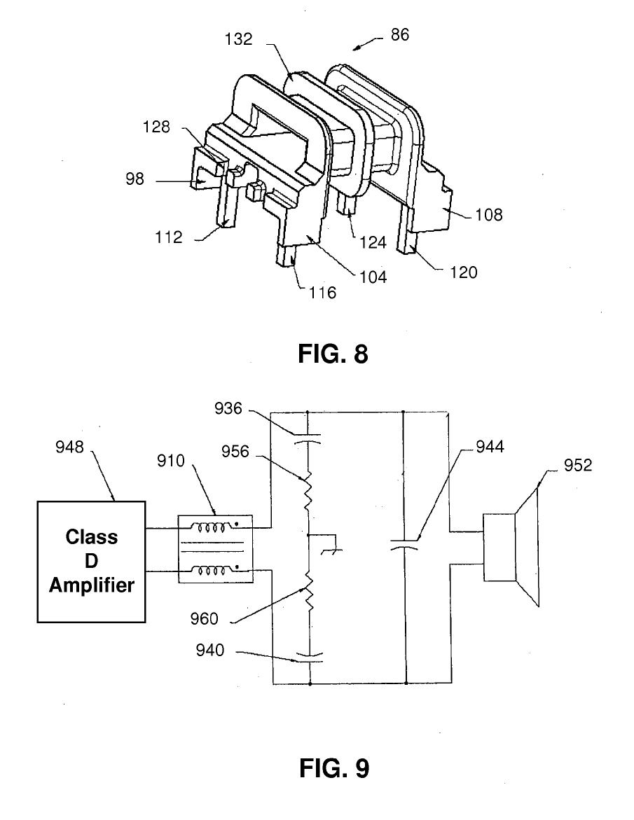

FIG. 9 shows a digital amplifier output filter schematic utilizing the integrated common mode and differential mode inductor, here identified as 910. One of skill in the art will recognize that numerous variations on this circuit are possible. Capacitors 936 and 940 are in series and then paralleled with capacitor 944 to form a low pass filter with the differential mode inductance of the inductor 910. This filter characteristic removes most of the carrier frequency from the class D amplifier 948 before it gets to the speaker 952. The common mode filter equivalent circuit of FIG. 9 does not have capacitor 944. The common mode filter characteristic is defined by the low pass filter formed by the paralleled capacitors 936 and 940 in series and the common mode inductance of the inductor 910. The common mode characteristics of the filter reduce EMI. The resistors 956 and 960 allow for additional damping to control overvoltage at the resonant frequencies of the low pass filters if enough damping is not provided or desired within the inductor 910.

Thus, the invention provides, among other things, an an integrated common mode and differential mode inductor for use with an audio filter. Various features and advantages of the invention are set forth in the following claims.

What is claimed is:

1. An inductor including common mode and differential mode flux paths, the inductor comprising:
a first core having a first connecting portion, a first segment extending from a first end of the connecting portion, a second segment extending from a second end of the connecting portion, and a first bridge segment extending from a middle of the connecting portion;
a first wiring arrangement at least partially disposed around the first segment;
a second core having a second connecting portion, a third segment extending from a first end of the connecting portion, a fourth segment extending from a second end of the connecting portion, and a second bridge segment extending from a middle of the connecting portion;
a second wiring arrangement at least partially disposed around the third segment;
a first suspension connecting the first segment to the fourth segment;
a second suspension connecting the second segment to the third segment;
wherein the first segment, second segment, third segment, and fourth segment cooperate to promote the common mode flux path, and the first bridge segment and the second bridge segment cooperate to promote the differential mode flux path and further wherein the pluralities of spheres affect the reluctance of the common mode inductance path.

2. The inductor of claim 1, further comprising a third wiring arrangement disposed at least partially disposed about one of the first segment and fourth segment and a fourth wiring arrangement disposed at least partially around one of the second segment and third segment.

3. The inductor of claim 2, further comprising a first bobbin supporting the first and third wiring arrangements and a second bobbin supporting the second and fourth wiring arrangements.

4. The inductor of claim 3, wherein the first bobbin has a flange disposed between the first and third wiring arrangements, and the second bobbin has a flange disposed between the second and fourth wiring arrangements.

5. The inductor of claim 3, further comprising a magnetic shield disposed between the first bobbin and second bobbin.

6. The inductor of claim 1, wherein the first suspension and second suspension include a plurality of solid spheres and an adhesive.

7. The inductor of claim 6, wherein the spheres are composed of a glass.

8. The inductor of claim 1, wherein the spheres are composed of a conductive material.

9. The inductor of claim 8, wherein the spheres are composed of a metal.

10. An inductor including common mode and differential mode flux paths, the inductor comprising:
a first core having a connecting portion, a first segment extending from a first end of the connecting portion, a second segment extending from a second end of the connecting portion, and a bridge segment extending from a middle of the connecting portion;
a first wiring arrangement at least partially disposed around the first segment;
a second wiring arrangement at least partially disposed around the second segment;
a second core having a first end, a second end and a middle portion between the first end and the second end;
a first plurality of solid spheres and an adhesive connecting the first segment to the first end;
a second plurality of solid spheres and an adhesive connecting the second segment to the second end;
wherein the first segment, second segment, first end, and second end cooperate to promote the common mode flux path, and the bridge segment and the intermediate portion cooperate to promote the differential mode flux path and further wherein the spheres affect the reluctance of the common mode inductance path.

11. The inductor of claim 10, wherein the spheres are composed of a conductive material.

12. The inductor of claim 10, wherein the spheres are composed of a non-conductive material.

13. The inductor of claim 10, wherein each plurality of spheres is a mixture of conductive spheres and non-conductive spheres.

14. The inductor of claim 10, wherein each sphere of the first plurality of spheres has a substantially equal diameter.

15. The inductor of claim 10, wherein each sphere of the first plurality of spheres and second plurality of spheres has a substantially equal diameter.

16. An integrated common mode and differential mode inductor, the inductor comprising:
a first core and a second core, each core having a first segment, a second segment, and a bridge between the first and second segments;
a first gap defined between the first segment of the first core and the second segment of the second core, the first gap including a plurality of solid spheres;
a second gap defined between the second segment of the first core and the first segment of the second core, the second gap including a plurality of solid spheres;
a third gap defined between the bridge of the first core and the bridge of the second core;
a first bobbin disposed around the first segment of the first core and the second segment of the second core;
a second bobbin disposed around the second segment of the first core and the first segment of the first core;
a first wiring arrangement and a second wiring arrangement disposed around the first bobbin;
a third wiring arrangement and a fourth wiring arrangement disposed around the second bobbin; and
a magnetic shield disposed between the first and second bobbin.

17. The integrated common mode and differential mode inductor of claim 16, wherein the first bobbin further comprises a plurality of terminals.

18. The integrated common mode and differential mode inductor of claim 17, wherein the first bobbin further comprises a plurality of standoffs to space the inductor from a board.

19. The integrated common mode and differential mode inductor of claim 17, further comprising a magnetic shield disposed intermediate the first bobbin and the second bobbin.
